(19) United States
(12) Patent Application Publication
(10) Pub. No.: US 2023/0303844 A1
(43) Pub. Date: Sep. 28, 2023

(54) Biodegradable Structures for Parties, Hunting and Other Events

(71) Applicant: Jason King, Fort McMurray (CA)

(72) Inventor: Jason King, Fort McMurray (CA)

(21) Appl. No.: 18/185,765

(22) Filed: Mar. 17, 2023

Related U.S. Application Data
(60) Provisional application No. 63/323,646, filed on Mar. 25, 2022.

(51) Int. Cl. C08L 97/02; C09D 191/06; E04H 3/24; A47C 1/12; E04H 15/00; E04H 15/34

(52) U.S. Cl. CPC C08L 97/02; C09D 191/06; E04H 3/24; A47C 1/12; E04H 15/001; E04H 15/008; E04H 15/34; C08L 2201/06

(57) ABSTRACT

The present invention relates to biodegradable structures for offering a way for individuals to relax outdoors in an environmentally-friendly and animal-friendly manner. The biodegradable structures include stages, bleachers, hunting blinds, and more, for enabling individuals to use the structures for enjoying an event and then leave the structures behind to biodegrade and naturally decompose over time to improve the proximal or adjacent environment. The structures can be used for different types of outdoor events and can come in different forms and sizes. The structures are formed of biodegradable materials like wood, cardboard, and biopolymers for fast decomposition in order to replenish the soil thereunder. The structures do not harm animals, nor the environment, while enabling individuals to enjoy the outdoors.

### CROSS-REFERENCE TO RELATED APPLICATION

The present application claims priority to, and the benefit of, U.S. Provisional Application No. 63/323,646, which was filed on Mar. 25, 2022 and is incorporated herein by reference in its entirety.

### FIELD OF THE INVENTION

The present invention relates generally to the field of outdoor events and biodegradable structures. More specifically, the present invention relates to biodegradable structures like stages, bleachers, hunting blinds, and more enabling individuals to use the structures for enjoying an event and leave the structures behind to biodegrade and hence helping in improving the environment. The structures come in various designs, sizes and forms to meet requirements of different types of events. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals enjoy outdoor events, functions, concerts and more. Especially, individuals enjoy small events in areas outside dense cities and use structures like stages, bleachers, beverage cans and more for conducting and enjoying such events. Stages, bleachers and other decorative items are made from metals, plastic, alloys and more and are expensive. Such objects are often left behind by the organizers and audiences after the event and such items interfere with natural habitat of animals and damage the environment as well. Organizers, individuals, and environmental activists want improved event organizing items that do not cause damage to environment and animals.

Hunters and outdoor enthusiasts often use hunting blinds which are concealment devices or shelters for hunters or gamekeepers, designed to reduce the chance of detection by game, birds, and/or animals. Commonly, hunting blinds are made of polyethylene or a metal which is non-biodegradable, but is also hard and can cause injury to both individuals and animals. There is a desire for improved hunting blinds that can naturally decompose over time and therefore, are safe for the environment and animals.

As a result of use of harmful and non-biodegradable structures, when most animals roam, they tend to avoid places where large groups of individuals can be found or where individuals tend to congregate. Animals also avoid going to places where stages, bleachers, hunting blinds, tents and more are found. Moreover, such items typically scare animals and therefore it is advantageous to use biodegradable items and structures that can decompose naturally over time and therefore, are safe for environment and animals.

Therefore, there exists a long felt need in the art for improved and biodegradable structures like bleachers, stages, tents, hunting blinds, and more. There is also a long felt need in the art for improved structures that can be used for outdoor picnics, events, hunting, and more. Additionally, there is a long felt need in the art for structures that decompose naturally over time. Moreover, there is a long felt need in the art for improved structures that can be used for organizing small and big events without affecting the environment and animals. Further, there is a long felt need in the art for improved structures that are lightweight, durable, and cost-effective. Finally, there is a long felt need in the art for biodegradable structures like stages, bleachers, hunting blinds, and more that offer a way for individuals to relax outdoors and to reduce the environmental impact therefrom.

The subject matter disclosed and claimed herein, in one embodiment thereof, comprises a kit of biodegradable structures configured to be used in an outdoor event or function. The kit offers a way for individuals to relax and enjoy outdoors and improve the environment. The kit further comprising a biodegradable expandable bleacher having a plurality of benches of seating; the bleacher is made of a frame of wood and has benches made of cardboard or wood; a biodegradable stage for enabling one or more performers to perform; the stage is made of wood; a plurality of biodegradable tents; each tent is made from cardboard and has a beeswax layer; a plurality of decorative items; each decorative item is made from a biodegradable polymer selected from polylactates and polyhydroxyalkanoates; wherein the structures starts to decompose naturally in two days to replenish soil and enhance the environment.

In this manner, the biodegradable structures of the present invention accomplish all of the forgoing objectives and provides users with biodegradable structures, such as, stages, bleachers, hunting blinds, and more. The structures are used by individuals for enjoying events, picnics, and more and then can be left behind to biodegrade for improving quality of soil and functioning as flower bed or animal housing. The structures are lightweight, durable, cost-effective, and come in a variety of sizes, designs, and forms.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a kit of biodegradable structures configured to be used in an outdoor event or function. The kit further comprising a biodegradable bleacher having a plurality of benches of seating; the bleacher is made of a frame of wood and has benches made of cardboard or wood; a biodegradable stage for enabling one or more performers to perform; the stage is made of wood; a plurality of biodegradable tents; each tent is made from cardboard and has a beeswax layer; a plurality of decorative items; each decorative item is made from a biodegradable polymer selected from polylactides' and polyhydroxyalkanoates; wherein the structures starts to decompose naturally in two days to replenish soil and enhance environment thereafter.

In yet another embodiment, the kit includes a biodegradable hunting blind or shelter made from about 1200 grams per square meter (GSM) cardboard and used for concealment from animals.

In yet another embodiment, naturally-decomposing structures for use in an outdoor party are disclosed. The structures include at least one biodegradable stage, a biodegradable and expandable bleacher, a plurality of biodegradable tents, a plurality of hunting blinds and a plurality of decorative vases. The biodegradable structures are made from natural wood, cardboard, and biopolymers wherein the structures are collapsible and can be made into flower beds or animal shelters before decomposing naturally.

In yet another embodiment, the structures include a plurality of biodegradable cups, a plurality of biodegradable plates, and a plurality of biodegradable glasses.

In yet another embodiment, a method of enjoying outdoor functions in an environment friendly manner is described. The method includes the steps of installing biodegradable bleaches, stages, tents, and decorative items; enjoying the outdoor function using the installed biodegradable structures; collapsing the biodegradable structures; automatically and naturally-decomposing of the biodegradable structures to replenish the soil.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a biodegradable structure of the present invention in accordance with the disclosed architecture;

FIG. 2 illustrates a perspective view of biodegradable hunting blind or shelter of the present invention in accordance with the disclosed architecture;

FIG. 3 illustrates a detailed view of a tent of the present invention in accordance with the disclosed architecture; and

FIG. 4 illustrates a flow diagram depicting an exemplary process of using one or more components of the biodegradable structures kit of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for improved and biodegradable structures like bleachers, stages, tents, hunting blinds, and more. There is also a long felt need in the art for improved structures that can be used for outdoor picnics, events, hunting, and more. Additionally, there is a long felt need in the art for structures that decompose naturally over time. Moreover, there is a long felt need in the art for improved structures that can be used for organizing small and big events without affecting the environment and animals. Further, there is a long felt need in the art for improved structures that are lightweight, durable, and cost-effective. Finally, there is a long felt need in the art for biodegradable structures like stages, bleachers, hunting blinds, and more that offer a way for individuals to relax outdoors and to reduce the environmental impact therefrom.

The present invention, in one exemplary embodiment, is a naturally-decomposing structures kit for use in an outdoor party function or event. The structures include at least one biodegradable stage, a biodegradable and expandable bleacher, a plurality of biodegradable tents, a plurality of hunting blinds and a plurality of decorative vases. The biodegradable structures are made from natural wood, cardboard, and biopolymers wherein the structures are collapsible and can be made into flower beds or animal shelters before decomposing naturally. The structures are environmentally-friendly, cost-effective, durable, and easy to use. The structures can also function as a flower bed or animal housing that naturally decomposes over time.

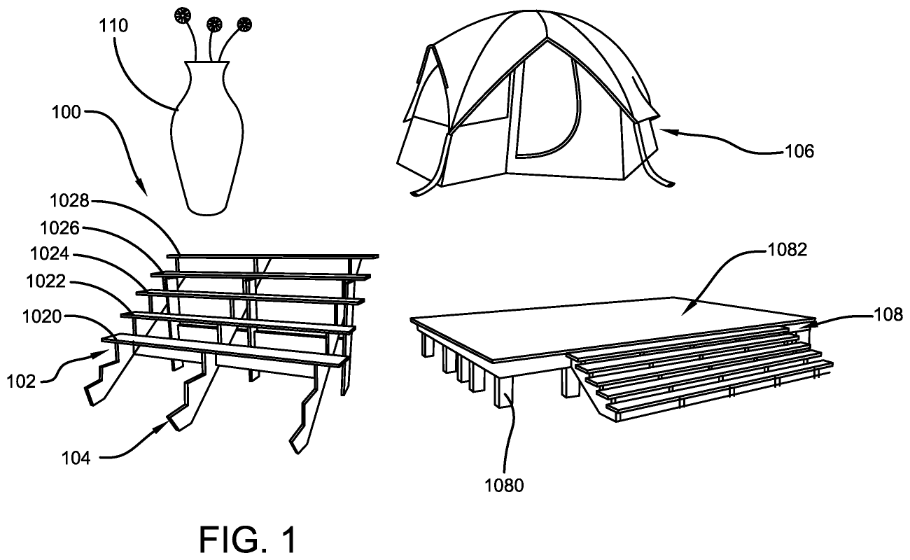

Referring initially to the drawings, FIG. 1 illustrates a perspective view of one potential embodiment of the biodegradable structure of the present invention in accordance with the disclosed architecture. The biodegradable structures kit 100 of the present invention include a plurality of individual components that are configured to be used by environmentally-conscious individuals who like to organize and attend functions, picnics and more. As illustrated, a biodegradable bleacher 102 having a plurality of tiered benches 1020, 1022, 1024, 1026, 1028 is used for seating for an event. The bleacher 102 maximizes seating area and can come in variety of sizes and number of benches. More specifically, the bleacher 102 is made of a wooden frame 104 and is biodegradable. The bleacher 102 can come in a variety of colors like red, blue, green, white, and more for giving an illusion of an energetic crowd. The benches 1020, 1022, 1024 may have embedded local seeds so that when the bleacher 102 disintegrates into the earth, green spaces can be rejuvenated.

A biodegradable tent or shelter 106 is designed to have a life of two days and then automatically begins to biodegrade. The tent or shelter 106 is configured to decompose and replenish soil. The tent or shelter 106 is made from cardboard and may have beeswax layer for protecting occupants therein from weather elements. The tent or shelter 106 is also embedded with plant seeds in the panels that are released during the tent's decomposition. The tent or shelter 106 can be designed to have up to three occupants and can come in different shapes and designs.

A biodegradable stage 108 is included in the kit 100 and is configured to be used by performers during an event or function. The stage 108 can be made of wood and cardboard and comes in different sizes to accommodate functions of different scales. The stage 108 has a frame 1080 and a platform 1082 upon which a performer can stand. In one embodiment, the frame can be made from a collapsible metal frame and can be designed as an extendable frame.

A plurality of decorative items 110 such as flower vase or more are included in the kit 100. The items 110 can be used for decorating a function or event space and can come in various forms and shape for different functions and events. The decorative items 110 may have any color or design and can be broken for a fast-decomposing process.

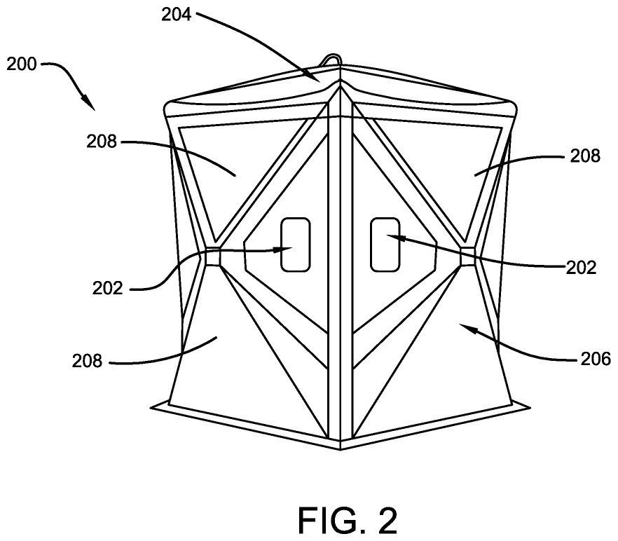

FIG. 2 illustrates a perspective view of biodegradable hunting blind or shelter of the present invention in accordance with the disclosed architecture. The biodegradable hunting blind or shelter 200 of the present embodiment is designed for accommodating one or more hunters during hunting of animals or birds. The blind 200 is made of cardboard with a layer of bamboo and biodegradable cellophane and starts to naturally decompose in two days. The blind 200 when decomposed replenishes the soil and helps in forming a greener space.

In some embodiments of the present invention, the blind 200 is made from polylactic acid plastics. Water can be poured on the blind 200 after use enabling the blind 200 to decompose for biodegrading.

The blind 200 can have a plurality of windows 202 for peering through the blind 200 and a top surface 204 for protecting the occupants from weather elements. The blind further includes a plurality of side panels 208. A door 206 is used for accessing the blind 200 for occupancy. It should be noted that the blind 200 can be a part of the kit 100 in the preferred embodiment. Further, any device or item required for conducting a successful and enjoyable function or event can be included in the kit 100 when manufactured in a biodegradable form. The additional items may include cups, plates, glasses and more.

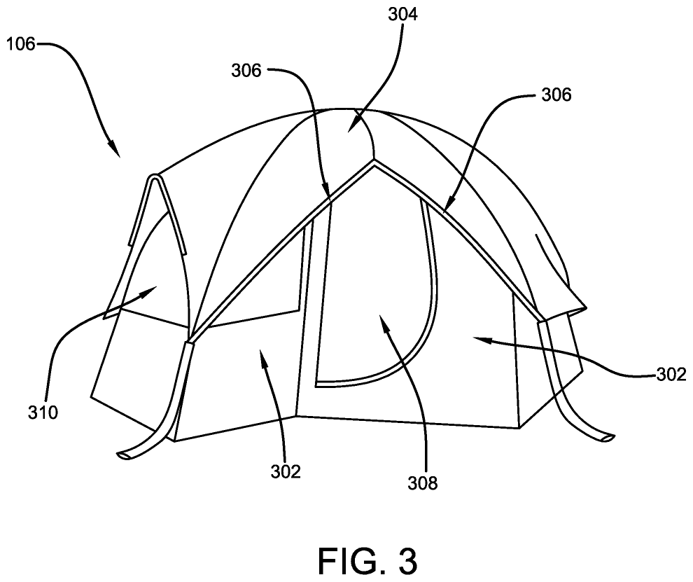

FIG. 3 illustrates a detailed view of the tent or shelter 106 of the present invention in accordance with the disclosed architecture. In the present embodiment, the tent or shelter 106 has side surfaces or panels 302 and a top surface 304. Rain gutters 306 are positioned along edges for managing rainwater. The tent or shelter 106 includes a door 308 and a plurality of windows 310 for ventilation and enabling entry and exit of individuals.

It should be noted that the tent or shelter 106 shown in the present embodiment is a simplified model, and poles and specific details for the tent or shelter 106 are not shown. However, the general configuration and manufacture of tents is known, and thus a specific configuration is omitted or simplified in order to not obscure the embodiments of the invention being described.

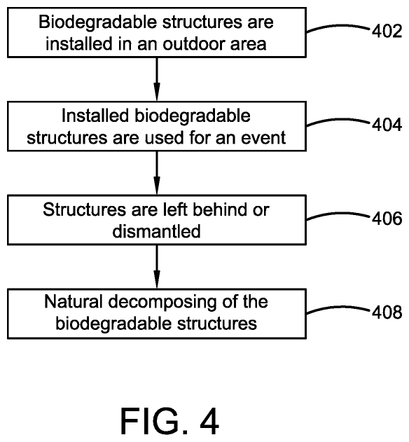

FIG. 4 illustrates a flow diagram depicting an exemplary process of using one or more components of the biodegradable structures kit of the present invention in accordance with the disclosed architecture. Initially, based on the type of outdoor function or event, one or more components are chosen and installed in an outdoor area (Step 402). Then, the installed components are used for a day or two depending on the duration of the event (Step 404). In the preferred embodiment, each of the components can be used for up to three days before disintegrating naturally.

Then, one or more components can be collapsed or dismantled to transform, decompose, or biodegrade into a flower bed or an animal housing (Step 406). Finally, after three days of installation, the components are decomposed naturally to replenish soil thereunder with nutrients without causing any environmental degradation and problems for animals (Step 408).

In one embodiment of the present invention, the biodegradable material for decorative items can be selected from cost-effective polylactates and polyhydroxyalkanoates. The thickness and durability of all the components of the kit 100, blind 200 and more are enough so that they retain their shapes, sizes, and structural integrity during use.

The present invention also uses biopolymers having a high degradability and the guarantee of quickly degrading. A wax preferably a natural wax, such as bees wax, carnauba wax, or the like, can be used for improving degradability properties. All the components can stick into the ground easily for a stable and secure positioning without any movement and slip.

Other shapes, designs and configurations of the biodegradable items are contemplated and fall within the scope of the invention without affecting the utility of the device. Since the devices are biodegradable, therefore, they can be left behind and used by animals as housing, degrading over time thereby offering a way for individuals to relax outdoors and then improve the environment thereafter.

The components of the present invention can be formed using natural wood such as teak, mango wood, oakwood, walnut oak, rubber wood, ash wood, and more. The cardboard used for making various items can, in one embodiment, include a GSM weight in the range from about 1100 GSM to about 1500 GSM. Further, in another embodiment, the cardboard can include a GSM weight in the range from about 1300 GSM to about 1500 GSM.

Certain terms are used throughout the following description and claims to refer to particular features or components. As one skilled in the art will appreciate, different persons may refer to the same feature or component by different names. This document does not intend to distinguish between components or features that differ in name, but not structure or function. As used herein “biodegradable objects”, “biodegradable items”, “biodegradable structures”, “biodegradable structures kit” and “kit” are interchangeable and refer to the biodegradable structures kit 100 of the present invention.

Notwithstanding the forgoing, the biodegradable structures kit 100 of the present invention can be of any suitable size and configuration as is known in the art without affecting the overall concept of the invention, provided that it accomplishes the above-stated objectives. One of ordinary skill in the art will appreciate the biodegradable structures kit 100 as shown in the FIGS. are for illustrative purposes only, and that many other sizes and shapes of the biodegradable structures kit 100 are well within the scope of the present disclosure. Although the biodegradable structures kit 100 includes important design parameters for user convenience, the biodegradable structures kit 100 can be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A biodegradable structure kit comprising:
a plurality of individual structural components for temporary use having biodegradable materials;
a biodegradable frame;
a plurality of biodegradable benches attached to said frame; and
wherein said benches including a cardboard material having a weight from about 1100 GSM to about 1500 GSM.

2. The biodegradable structure kit of claim 1, wherein said biodegradable frame having a material of wood.

3. The biodegradable structure kit of claim 2, wherein said wood is selected from a group consisting of a teak wood, a mango wood, an oakwood, a walnut oak, a rubber wood, and an ash wood.

4. The biodegradable structure kit of claim 3, wherein said biodegradable frame is a stage having a platform.

5. The biodegradable structure kit of claim 2, wherein said frame and said benches are decomposable.

6. A biodegradable shelter comprising:
a plurality of individual structural components for temporary use having biodegradable materials;
a biodegradable frame;
a plurality of biodegradable panels;
wherein said panels including a cardboard material having a weight from about 1100 GSM to about 1500 GSM; and
further wherein said cardboard material having a wax layer.

7. The biodegradable shelter of claim 6, wherein said biodegradable frame having a material of wood.

8. The biodegradable shelter of claim 7, wherein said wax layer having a wax selected from a group consisting of a natural wax, a bees wax, and a carnauba wax.

9. The biodegradable shelter of claim 7, wherein said panels including a cardboard material having a weight from about 1300 GSM to about 1500 GSM.

10. The biodegradable shelter of claim 7, wherein said shelter is a tent.

11. The biodegradable shelter of claim 7, wherein said shelter is a hunting blind.

12. The biodegradable shelter of claim 10, wherein said panels include plant seeds embedded in said panels.

13. The biodegradable shelter of claim 11, wherein said panels include plant seeds embedded in said panels.

14. The biodegradable shelter of claim 7, wherein said cardboard layer having a bamboo layer.

15. The biodegradable shelter of claim 10, wherein said panels include windows having biodegradable cellophane.

16. A biodegradable shelter comprising:
a plurality of individual shelter components for temporary use having biodegradable materials;
a biodegradable frame;
a plurality of biodegradable panels; and
wherein said panels having a material of polylactic acid plastic.

17. The biodegradable shelter of claim 16, wherein said biodegradable frame having a material of wood.

18. The biodegradable shelter of claim 17, wherein said panels include a wax layer having a wax selected from a group consisting of a natural wax, a bees wax, and a carnauba wax.

19. The biodegradable shelter of claim 18, wherein said shelter is a tent and said panels include plant seeds embedded in said panels.

20. The biodegradable shelter of claim 18, wherein said shelter is a hunting blind and said panels include plant seeds embedded in said panels.
